(19) United States
(12) Patent Application Publication
(10) Pub. No.: US 2023/0124662 A1
(43) Pub. Date: Apr. 20, 2023

(54) SYSTEM AND METHOD FOR CAPTURING AN EVENT OF RANDOM OCCURANCE AND LENGTH FROM A STREAM OF CONTINUOUS INPUT DATA

(71) Applicant: CRON SYSTEMS PVT. LTD., New Delhi (IN)

(72) Inventors: Saurav AGARWALA, New Delhi (IN); Tushar CHHABRA, New Delhi (IN)

(21) Appl. No.: 18/082,003

(22) Filed: Dec. 15, 2022

Related U.S. Application Data
(63) Continuation of application No. PCT/IB2021/055260, filed on Jun. 15, 2021.

(30) Foreign Application Priority Data
Jun. 15, 2020 (IN) 202011025170

(51) Int. Cl. G06V 20/40; G06V 20/52

(52) U.S. Cl. CPC G06V 20/44; G06V 20/52

(57) ABSTRACT

A method is provided for capturing an event of random occurrence and length from a stream of continuous input data. The method includes recording sequential data streams using one or more data capturing devices monitoring a space, each sequential data stream having a predefined duration, creating a first pool of sequential data streams and storing up to a predefined number of sequential data streams at any time in the first pool, receiving an event trigger from one or more sensing devices, indicative of an occurrence of the event, creating a second pool of recorded sequential data streams after receiving the event trigger, by copying sequential data streams from the first pool till a completion of the event plus a predetermined duration post the occurrence of the event, and merging and processing the sequential data streams of the event from the second pool to form a single continuous data stream.

### CROSS-REFERENCE TO RELATED APPLICATIONS

This application is a continuation of International Patent Application No. PCT/162021/055260, filed Jun. 15, 2021, which claims priority from Indian Patent Application No. 202011025170, filed Jun. 15, 2020, and these applications are incorporated herein by reference for all purposes as if fully set forth herein.

### FIELD OF THE INVENTION

Embodiments of the present invention generally relate to recording of unpredictable events. Particularly, present disclosure relates to system and method for capturing an event of random occurrence and length from a stream of continuous input data, while optimizing the storage and computational resources.

### BACKGROUND OF THE INVENTION

Data recording has been a well-known technology that has been in use for a wide variety of purposes such as monitoring an office space, aerospace, parking lots, radar detection, monitoring objects in a production line, and the like. Specifically capturing and storing audio and video data has become more accessible with the availability of large data storage units. However, capturing a real-time event such as natural phenomenon like lightening, sandstorm or an occurrence in data produced by LiDARs, Radars, Sound Systems, Cameras is random in terms of their time of occurrence as well as the duration of occurrence and a user or machine or system has no prior information of the event. Hence, accurately capturing or recording such an event which is random in terms of time of occurrence as well as duration of occurrence is very difficult and cannot be done by prediction.

In such scenarios where events are to be captured which are random in terms of their time of occurrence as well as duration of occurrence, it is required to intelligently record these events in streamed data for post analysis. Continuous data stream storage is expensive and computationally demanding. Moreover, analytics on stored large data sets requires further large computational and human resources.

Such a recording of an event which is random both in terms of its time of occurrence as well as duration of occurrence from a source of continuous streamed data also requires capturing data for a definite amount of time before the random event actually occurred and for a definite amount of time after the random event finished for post analysis to understand the circumstances under which such an event occurred and to analyse the outputs or effects of the event. Conventionally, real-time streamed data is captured and recorded for all duration. Such large amount of data is then time tagged to when the random event occurred and the duration for which it occurred. Then a user may either seek to the timings or later trim the part of the continuously recorded data stream to find the required duration of data stream. For example, continuous recording of data stream for 10 seconds from a solid state lidar capturing 22.5 Million Points per second occupies a disk space of more than 350 megabytes. A continuous recording of 60 seconds of data stream of 4K video at 30 fps occupies a disk space of more than 375 megabytes. Hence continuous recording and capturing of these data streams is not only a wastage of storage but also requires a lot of effort for post analysis. Hence if the system continuously records all the data streams from the above-mentioned LiDAR and a 4K video at 30 fps, in a day it would have recorded data streams worth storage of 3.024 terabytes and 540 gigabytes respectively. Again, if the system continuously records all the data streams from the above-mentioned LiDAR and a 4K video at 30 fps, in a year it would have recorded data streams worth storage of 1103.76 terabytes and 197.1 terabytes respectively. Also, this approach requires a lot of efforts for post analysis, as the event needs to be searched with the time tag from the entire recording of the continuous stream of data.

Hence, there exists a need for system and method for capturing an event of random occurrence and length from a stream of continuous input data, including a brief duration before and after the event. Further, the system and method should be cost effective, requiring minimal storage means, and easy to analyse.

### OBJECT OF THE INVENTION

An object of the invention is to provide system and method for capturing an event of random occurrence and length from a stream of continuous input data, including a brief pre-event data and post event data.

Another object of the invention is to provide a system and a method for capturing random event that requires minimal space for storing the relevant data.

Yet another object of the invention is to provide a system and a method to individually capture multiple random events occurring at the same time or different time intervals.

Yet another object of the invention is to provide a system and a method for capturing random event which requires minimal processing means for post analytics.

Yet another object of the present invention is to provide a system and a method of capturing and recording pre-event data, event data and post event data enabling faster and less laborious post analytics.

### SUMMARY OF THE INVENTION

According to a first aspect of the present invention, there is provided a method for capturing an event of random occurrence and length from a stream of continuous input data. The method comprises recording sequential data streams using one or more data capturing devices monitoring a space, each sequential data stream having a predefined duration; creating a first pool of sequential data streams in a data repository and storing up to a predefined number of sequential data streams at any time in the first pool; receiving an event trigger from one or more sensing devices, indicative of an occurrence of the event which is random in terms of occurrence and duration; creating a second pool of recorded sequential data streams in the data repository after receiving the event trigger, by copying sequential data streams from the first pool till a completion of the event plus a predetermined duration post the occurrence of the event; and merging and processing the sequential data streams of the event from the second pool to form a single continuous data stream, thereby capturing the occurrence of the unpredictable event along with predefined pre and post event time.

In accordance with an embodiment of the present invention, the method further comprises the steps of capturing multiple sequential data streams associated with occurrence of multiple events which are random in terms of occurrence and duration, at the same time and/or at different time intervals during the recording.

In accordance with an embodiment of the present invention, the time-based data streams are selected from videos, audio data, point cloud data, text data, data points in 2D/3D, noise generated by machines, radiations from an energy source or a combination thereof.

In accordance with an embodiment of the present invention, the event to be detected is selected from surveillance and security related events, crowd monitoring-based events such as theft, shoplifting, social distancing violations, criminal activity and traffic violations; and natural phenomenon such as lightening, natural disasters, which are random in terms of duration and occurrence.

In accordance with an embodiment of the present invention, each sequential data stream in the first pool of sequential data streams has a predefined duration ranging from predetermined number of seconds to hours depending upon the available storage space.

In accordance with an embodiment of the present invention, oldest recorded video is automatically deleted from the first pool of sequential data streams when number of sequential data streams stored therein exceed the predetermined number, thereby saving a lot of storage pace.

In accordance with an embodiment of the present invention, the predetermined number of sequential data streams is selected from 3 to 5, depending upon the available storage space and the predefined length of each sequential data stream.

In accordance with an embodiment of the present invention, the one or more data capturing devices are selected from visual cameras, audio systems, ultrasonic sensors and 3D sensors such as radars, LiDARs, Laser Detection and Ranging (LaDAR), Light Emitting Diode Detection and Ranging (LeDDAR) mmWave Radar, C or K Band Radar, laser scanners and Time of Flight (ToF) sensors.

In accordance with an embodiment of the present invention, the one or more sensing devices for detecting the occurrence of an event are selected from cameras, ultrasonic sensors, proximity sensors, tamper detection sensors, Infrared sensors, luminosity sensors, Vibration Sensors, Optical Fibre Sensor, acoustic sensors, sound sensors, automotive sensors, chemical sensors, electric current sensors, electric potential sensors, magnetic sensors, radio sensors, environment sensors, weather sensors, moisture sensors, humidity sensors, Flow & fluid velocity sensors, ionizing radiation sensors, subatomic particles sensors, navigation sensors, position sensors, angle sensors, displacement sensors, distance sensors, speed sensors, acceleration sensors, imaging sensors, photon sensors, pressure sensors, force, density & level sensors, thermal sensors, heat & temperature sensors, 3D sensors and a combination thereof.

In accordance with an embodiment of the present invention, the event trigger may be received from one or more external computing devices selected from PC, laptop, smartphones and PDA that enable a user to manually trigger the event detection.

According to a second aspect of the present invention, there is provided system for capturing an event of random occurrence and length from a stream of continuous input data. The system comprises one or more data capturing devices disposed in a space to be monitored; a data repository; one or more sensing devices; and a processing module connected with the one or more data capturing devices, the data repository and the one or more sensing devices. The processing module comprises a memory unit configured to store machine-readable instructions; and a processor operably connected with the memory unit. The processor obtains the machine-readable instructions from the memory unit, and is configured by the machine-readable instructions to record sequential data streams using one or more data capturing devices monitoring a space, each sequential data stream having a predefined duration; create a first pool of sequential data streams in a data repository and storing up to a predefined number of sequential data streams at any time in the first pool; receive an event trigger from the one or more sensing devices, indicative of an occurrence of the event which is random in terms of occurrence and duration; create a second pool of recorded sequential data streams in the data repository after receiving the event trigger, by copying sequential data streams from the first pool till a completion of the event plus a predetermined duration post the occurrence of the event; and merge and process the recorded sequential data streams of the event from the first pool and the second pool to form a single continuous data stream, thereby capturing the occurrence of the unpredictable event along with predefined pre and post event time.

In accordance with an embodiment of the present invention, the processor is configured to capture multiple sequential data streams associated with occurrence of multiple events which are random in terms of occurrence and duration, at the same time and/or at different time intervals during the recording.

In accordance with an embodiment of the present invention, the time-based data streams are selected from videos, audio data, point cloud data, text data, data points in 2D/3D, noise generated by machines, radiations from an energy source or a combination thereof.

In accordance with an embodiment of the present invention, the event to be detected is selected from surveillance and security related events, crowd monitoring-based events such as theft, shoplifting, social distancing violations, criminal activity and traffic violations; and natural phenomenon such as lightening, natural disasters, which are random in terms of duration and occurrence.

In accordance with an embodiment of the present invention, each sequential data stream in the first pool of sequential data streams has a predefined duration ranging from predetermined number of seconds to hours depending upon the available storage space.

In accordance with an embodiment of the present invention, the processor is configured to delete the oldest recorded sequential data stream automatically from the first pool of sequential data streams when number of sequential data streams stored therein exceed the predetermined number, thereby saving a lot of storage pace.

In accordance with an embodiment of the present invention, the predetermined number of sequential data streams is selected from 3 to 5, depending upon the available storage space and the predefined length of each sequential data stream.

In accordance with an embodiment of the present invention, the one or more data capturing devices are selected from visual cameras, audio capturing devices, ultrasonic sensors and 3D sensors such as radars, LiDARs, Laser Detection and Ranging (LaDAR), Light Emitting Diode Detection and Ranging (LeDDAR) mmWave Radar, C or K Band Radar, laser scanners and Time of Flight (ToF) sensors.

In accordance with an embodiment of the present invention, the one or more sensing devices for detecting the occurrence of an event are selected from cameras, ultrasonic sensors, proximity sensors, tamper detection sensors, Infrared sensors, luminosity sensors, Vibration Sensors, Optical Fibre Sensor, speed sensors, acoustic sensors, sound sensors, automotive sensors, chemical sensors, electric current sensors, electric potential sensors, magnetic sensors, radio sensors, environment sensors, weather sensors, moisture sensors, humidity sensors, Flow & fluid velocity sensors, ionizing radiation sensors, subatomic particles sensors, navigation sensors, position sensors, angle sensors, displacement sensors, distance sensors, acceleration sensors, imaging sensors, photon sensors, pressure sensors, force, density & level sensors, thermal sensors, heat & temperature sensors, 3D sensors and a combination thereof.

In accordance with an embodiment of the present invention, the system further comprises one or more external computing connected with the processor and the event trigger is received at the processor from devices selected from PC, laptop, smartphones and PDA that enable a user to manually trigger the event detection.

According to a third aspect of the present invention, there is provided a method for capturing an event of random occurrence and length from a stream of continuous input data. The method comprises recording sequential videos using one or more data capturing devices monitoring a space, each sequential video having a predefined duration; creating a first pool of sequential videos in a data repository and storing up to a predefined number of sequential videos at any time in the first pool; receiving an event trigger from one or more sensing devices, indicative of an occurrence of the event which is random in terms of occurrence and duration; creating a second pool of recorded sequential videos in the data repository after receiving the event trigger, by copying sequential videos from the first pool till a completion of the event plus a predetermined duration post the occurrence of the event; and merging and processing the sequential videos of the event from the second pool to form a single video sequence, thereby capturing the occurrence of the unpredictable event along with predefined pre and post event time.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments.

These and other features, benefits and advantages of the present invention will become apparent by reference to the following text figure, with like reference numbers referring to like structures across the views, wherein:

FIG. 1A illustrates a system for capturing an event of random occurrence and length from a stream of continuous input data, in accordance with an embodiment of the present invention;

FIG. 1B illustrates a block diagram of a processing module of the system of FIG. 1A, in accordance with an embodiment of the present invention;

FIG. 2 illustrates a method for capturing an event of random occurrence and length from a stream of continuous input data, in accordance with an embodiment of the present invention; and

FIG. 3A-3B illustrate information flow and an exemplary implementation of system and method shown FIG. 1A and FIG. 2, in accordance with an embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope.

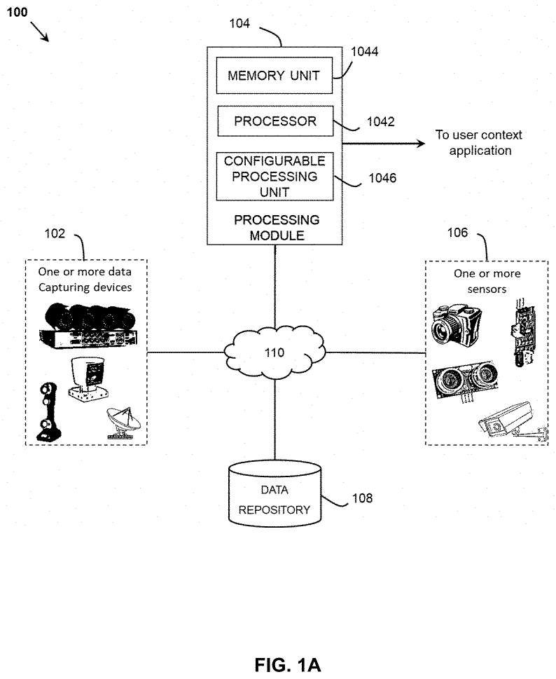

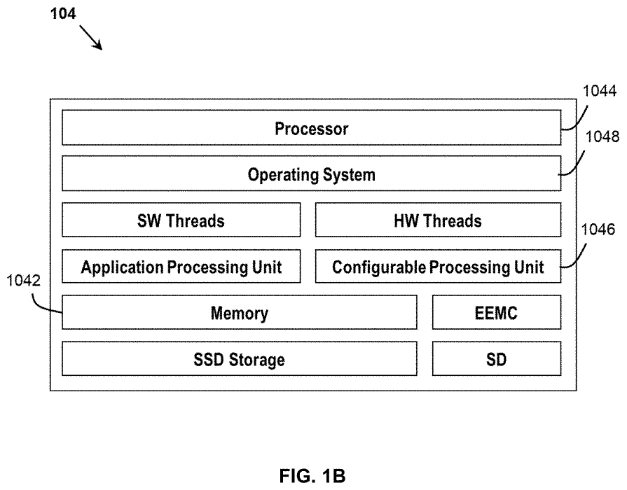

FIG. 1A illustrates a system (100) capturing an event of random occurrence and length from a stream of continuous input data, in accordance with an embodiment of the present invention. Herein, the event to be detected is selected from, but not limited to, surveillance and security related events, crowd monitoring-based events such as theft, shoplifting, social distancing violations, criminal activity and traffic violations; and natural phenomenon such as lightening, natural disasters, computer hardware/software errors, mechanical faults, signal processing errors etc. which are random in terms of duration and occurrence.

As shown in FIG. 1, the system (100) comprises of one or more data capturing devices (102) and one or more sensing devices (106) disposed in a space to be monitored, a data repository (108) and a processing module (104). The space may be, but not limited to, 3D space/surrounding, any establishment or an environment of computing devices, mechanical/electronic machines etc. where the present system (100) is being implemented. The processing module (102) is connected with each of the one or more data capturing devices (102), one or more sensing devices (106) and a data repository (108). The processing module (104) may further be connected with a user context application such as, but not limited to, surveillance, intrusion detection, disaster management, astronomy, atmosphere, crowd management, airport monitoring, biology and conservation, Forestry, Geology, Law enforcement, Mining, Image Recognition, Surveying, robotics, debugging, machine maintenance, signal processing, speech analysis, speech recognition and intelligent systems.

The one or more data capturing devices (102) are selected from, but not limited to, visual cameras, audio capturing devices (such as microphones etc.), ultrasonic sensors and 3D sensors such as radars, LiDARs, Laser Detection and Ranging (LaDAR), Light Emitting Diode and Ranging (LeDDAR) mmWave Radar, C or K Band Radar, laser scanners and Time of Flight (ToF) sensors. Herein, the visual camera may be, but not limited to, dome camera, bullet camera, Pan-Tilt-Zoom (PTZ) camera, C-mount Camera, Day/Night Camera, varifocal camera, HD camera and any other camera capable of continuously recording video. In one embodiment, the one or more data capturing devices (102) have integrated sound capturing means such as a microphone.

The one or more data capturing devices (102) are envisaged to capture the data in a continuous/sequential data stream of a plurality of objects, inside the space where the one or more data capturing devices (102) are positioned. In an aspect, a sequential data stream is a data stream having time sequence based data, for example, a video stream having a series of frames wherein each frame having an associated time with it.

The time-based data streams are selected from videos, audio data, point cloud data, text data, data points in 2D/3D, noise generated by machines, radiations from an energy source or a combination thereof. This means that the present invention could be extended from videos to any data which is a sequential/continuous data stream. Video from a camera is just an example of the sequential continuous data stream. More examples are audio stream, speeches made, noise generated by machines, logs or texts produced by a machine or code, point cloud 3D data from 3D sensors, radiations from an energy source, etc. The plurality of objects may be all kinds of living and non-living objects selected from a group comprising, but not limited to, humans of multiple age groups, animals, furniture, vehicles, natural resources, eatables, crops, infrastructure, stationery, sign boards, wearables, musical instruments, sports equipment, mechanical tools, electrical equipment & electronic equipment.

Additionally, the one or more sensing devices (106) may be, but not limited to, cameras, ultrasonic sensors, proximity sensors, tamper detection sensors, Infrared sensors, luminosity sensors, Vibration Sensors, Optical Fibre Sensor, acoustic sensors, sound sensors, automotive sensors, chemical sensors, electric current sensors, electric potential sensors, magnetic sensors, radio sensors, environment sensors, weather sensors, moisture sensors, humidity sensors, Flow & fluid velocity sensors, ionizing radiation sensors, subatomic particles sensors, navigation sensors, position sensors, angle sensors, displacement sensors, distance sensors, acceleration sensors, imaging sensors, photon sensors, pressure sensors, force, density & level sensors, thermal sensors, heat & temperature sensors, 3D sensors and a combination thereof. The list of sensors is not exhaustive and any type of sensors that can be used to detect an occurrence of an event is envisaged to be included within the scope of the present invention. The one or more sensing devices (106) are used to detect the event which is unpredictable in terms of occurrence and duration. For example: a black and white camera or a luminosity sensor may be used to detect lightening in the sky OR a proximity/Infrared/tamper detection sensor in a showroom may be used to detecting robbery/theft in a showroom during non-working hours. Upon detection of such event, an event trigger may be sent to the processing module.

In one embodiment, the system (100) may further comprise one or more external computing devices (not shown) connected with the processing module (104). The one or more external computing devices selected from PC, laptop, smartphones and PDA that enable the user to manually trigger the event detection. For example, if the user is monitoring a showroom remotely on his smartphone and he/she sees an unwanted person inside the showroom on his smartphone, so he/she can manually trigger the event using the smartphone itself. In another embodiment, the system (100) may not include the one or more sensing devices (106) and only use the one or more external computing devices. But that system would not be completely automatic. In yet another embodiment, the system (100) may use both the one or more sensing devices (106) and the one or more external computing devices in combination.

In yet another embodiment, the system (100) may not include any of the one or more sensing devices (106) or the one or more external computing device and may simply employ object/event detection algorithms for detection of an event. These may include using clustering algorithms, brute force or a combination thereof. In yet another embodiment, all or any these above mentioned devices and algorithms may be used in combination, depending upon the user context application.

Further, the processing module (104) is envisaged to include computing capabilities such as a memory unit (1042) configured to store machine readable instructions. The machine-readable instructions may be loaded into the memory unit (1042) from a non-transitory machine- readable medium, such as, but not limited to, CD-ROMs, DVD-ROMs and Flash Drives. Alternately, the machine-readable instructions may be loaded in a form of a computer software program into the memory unit (1042). The memory unit (1042) in that manner may be selected from a group comprising EPROM, EEPROM and Flash memory. The processing module (104) has been shown in a detailed block diagram in FIG. 1B, in accordance with an embodiment of the present invention.

The processing module (104) has been shown in a detailed block diagram in FIG. 1B, in accordance with an embodiment of the present invention. As shown in FIG. 1B, the processing module (104) includes a processor (1044) operably connected with the memory unit (1042). In various embodiments, the processor (1044) may be a microprocessor selected from one of, but not limited to a ARM based or Intel based processor (1044) in the form of field-programmable gate array (FPGA), a general-purpose processor and an application specific integrated circuit (ASIC). Additionally, the processing module (104) having a Heterogeneous Multi Core may further include a configurable processing unit (1046), an operating system (1048), an Application Processing Unit (APU), Hardware (HVV) threads, Software (SVV) threads, SSD storage, EMCC, SD etc.

The Application Processing Unit (APU) is enabled for highly sequential processing and the configurable processing unit (1046) is enabled for parallel execution, customization, deep pipelining as a custom soft logic core to improve performance and energy efficiency. Further, the operating system (1048) has been implemented for the configurable processing unit (1046) to offer a unified multithreaded programming model and OS services for threads executing in software and threads mapped to the configurable hardware. The Operating System (1048) semantically integrates hardware accelerators into a standard OS environment for rapid design-space exploration, to support a structured application development process, and to improve the portability of applications between different Reconfigurable Processing Systems. The Operating System (1048) makes sure that from the perspective of an application, it is completely transparent whether a thread is executing in software or hardware.

Hence when the recording, capturing, processing and merging requires less processing or efficiency as in the case of a single event trigger at a time with data being captured from a single data capturing device, the entire processing could be done on the APU. But in a case where more than one data capturing devices (102) are used and multiple triggers are to be received by the system (100) simultaneously, then the parallel execution can be accelerated as a custom soft logic core to improve performance and energy efficiency.

Moreover, the processing module (104) may implement artificial intelligence and deep learning-based technologies for, but not limited to, data analysis, collating data & presentation of data in real-time.

In accordance with an embodiment of the present invention, a communication network (110) may also be used in the system (100) for connecting the components within the system (100) or connecting the processing module (104) with a remote analytic system (100). The communication network (110) can be a short-range communication network and/or a long-range communication network, wire or wireless communication network. The communication interface includes, but not limited to, a serial communication interface, a parallel communication interface or a combination thereof. The communication network (110) may be implemented using a number of protocols, such as but not limited to, TCP/IP, 3GPP, 3GPP2, LTE, IEEE 802.x etc. The communication network (110) may be wireless communication network selected from one of, but not limited to, Bluetooth, radio frequency, internet or satellite communication network providing maximum coverage.

Additionally, the system (100) further includes the data repository (108). The data repository (108) may be a local storage (such as SSD, eMMC, Flash, SD card, etc.) or a cloud-based storage. In any manner, the data repository (108) is envisaged to be capable of providing the data to the processing module (104), when the data is queried appropriately using applicable security and other data transfer protocols. Herein, the data repository (108) is envisaged to store sequential data streams recorded using the one or more data capturing devices (102).

In one embodiment, the data repository (108) may also store the data and deep learning trained models of the multiple objects of all kinds of living and non-living objects selected from a group comprising, but not limited to, humans of multiple age groups (along with their physical characteristics & features), animals, plants, furniture, vehicles, natural resources, eatables, crops, infrastructure, stationery, sign boards, wearables, musical instruments, sports equipment, mechanical tools, electrical equipment, electronic equipment, and the like. In accordance with an embodiment of the present invention, the data repository (108) may be used for comparison with the detected objects for their identification and classification and/or in case, an object detected is an unseen object, then such objects may be stored for future reference.

In one aspect, the system (100) may be implemented in an embedded system (100) having the one or more data capturing devices (102), the one or more sensing devices (106), the data repository (108) and the processing module (104). In another aspect, the system (100) may be a distributed system with the one or more data capturing devices (102) and the one or more sensing devices (106) being externally disposed and connected with the processing module (104) & the data repository (108) in a separate computing device. A person skilled in the art would appreciate that the system (100) may be implemented in a plurality of ways.

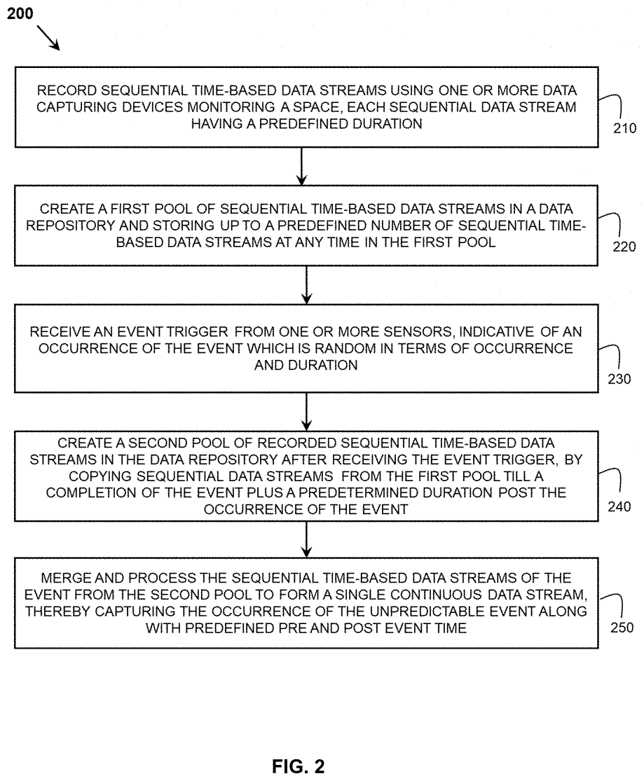

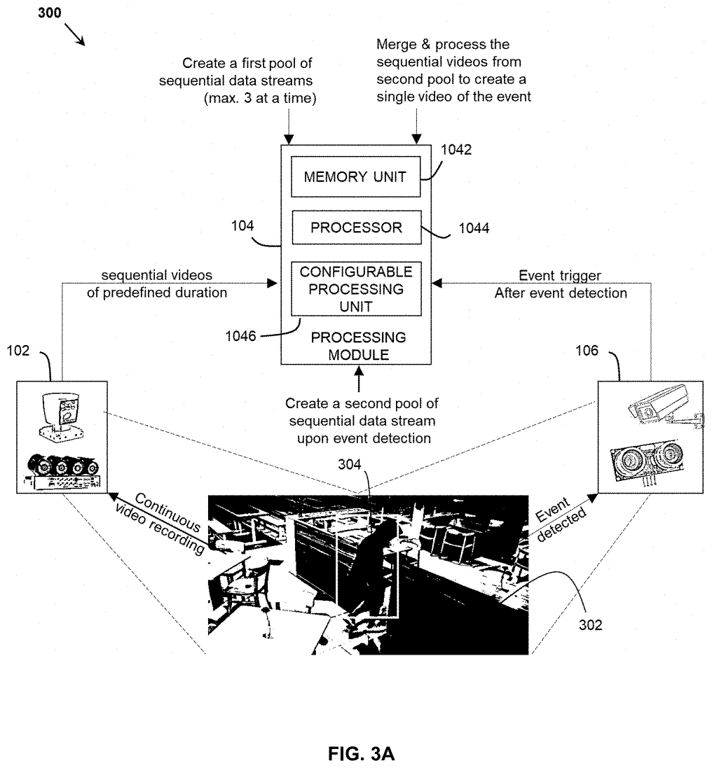

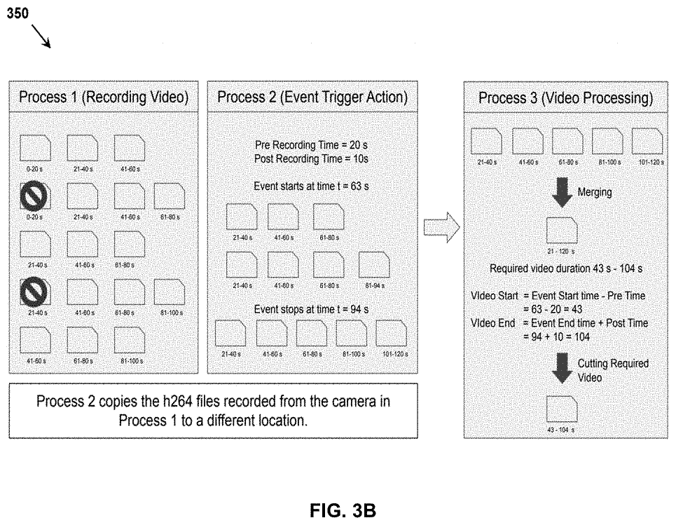

FIG. 2 illustrates a method (200) for capturing an event of random occurrence and length from a stream of continuous input data, in accordance with an embodiment of the present invention. This method (200) would be understood more clearly with the help of an exemplary implementation and information shown in FIG. 3A & 3B. The FIG. 3A illustrates a practical implementation of the present invention in a restaurant and the FIG. 3B illustrates the same in terms of information flow.

As shown in FIG. 2, the method (200) starts at step 210, by recording sequential data streams using one or more data capturing devices (102) monitoring a space. Each sequential data stream has a predefined duration. The time-based data streams are selected from, but not limited to, videos, audio data, point cloud data, text data, data points in 2D/3D or a combination thereof. So, referring to the example shown in FIG. 3A, it is shown that the space (302) to be monitored is the restaurant for any unwanted intrusion during non-working hours. The restaurant is being monitored using one or more data capturing devices (102), which may be a LiDAR or visual cameras as shown in FIG. 3A. Herein, the one or more data capturing devices (102) continuously record video and provide a continuous data stream to the processor (1044). The duration of each sequential video is limited to a predefined number of seconds, minutes or hours, depending upon the nature of the event and available storage. Herein, we assume that the video is recorded using the camera in a h264 format and the predefined duration for each sequential video is 20 seconds. The same has been shown to be part of “process 1” in FIG. 3B.

Returning to FIG. 2, at step 220, the processor (1044) is configured to create a first pool of sequential data streams in a data repository (108) and storing up to a predefined number of sequential data streams at any time in the first pool. So, in presently available solutions for monitoring, all the captured data has to be continuously stored irrespective of when (& if) an unpredictable event occurs. For example: the restaurant will have to store the data captured right from the time when the monitoring was initialised in the morning, even though the intrusion took place late at night for only a few seconds.

So, in order to overcome above mentioned drawback, the first pool of sequential data streams is created in the data repository (108) and is envisaged to have, only a predetermined number of data streams (i.e. videos in the present example) at any given time. The number of videos may increase or decrease depending on the storage space available. For example, only 3 recorded video data streams may be stored before the occurrence of the event. So, in that sense, it may infer that the maximum duration of pre event time video available for such a configuration is 3*20=60 seconds, which saves a huge amount storage pace and post processing. So, the moment 4th video of 20 seconds starts getting recorded, the first video in the pool or as to say the oldest recorded video in the pool is automatically deleted or transferred to another storage device. It is to be noted that the above-mentioned numbers are only exemplary and meant for simple explanation. However, the first pool of sequential data streams may store “n” no. of videos and as soon as n+1^{th} video starts recording, the oldest video is automatically deleted or transferred.

Additionally, as shown in FIG. 3A, the space (302) (i.e. the restaurant) is also being monitored using one or more sensing devices (106). Like, in the illustrated example, proximity and ultrasonic sensors have been disposed in the space (302) for detection of any object or movement inside the restaurant. Such detection or movement would be indicative of the intrusion (i.e. the event to be detected) as these are non-working hours, so no one should be present in the restaurant. It will be understood by a skilled addressee that sensors are chosen according to the event to be detected.

Further, at step 230, the processor (1044) receives an event trigger from one or more sensing devices (106). The event trigger herein indicates an occurrence of the event. As can be understood by a skilled addressee, that the event is random and unpredictable as no one can predict when can the intrusion occur or it's duration. Also, as can be seen from FIG. 3A, an intruder (304) is detected by the one or more sensing devices (106) and accordingly event trigger is sent to the processor (1044). To understand it more clearly, refer to FIG. 3B. It is assumed that the occurrence/start of the event is triggered at a t=63 seconds and goes on till t=94 seconds (again detected by the one or more sensing devices (106)). This means that as soon as recording from 61^{st} second started, the oldest video covering 1-20 seconds had been deleted.

In one embodiment, there may be a single event trigger that turns on upon detection of the occurrence of the event and turn off after event has occurred. In another embodiment, there may be a positive trigger and a negative trigger, wherein the positive trigger actuates upon detection and during the event; while negative trigger is active when no event is detected. In yet another embodiment, there may be a first trigger at the start of the event and a second trigger at the end of the event.

Returning to FIG. 2, at step 240, the processor (1044) creates a second pool of recorded sequential data streams in the data repository (108) after receiving the event trigger. This includes copying sequential data streams from the first pool till a completion of the event along with a predetermined duration post the occurrence of the event. For example, as shown in FIG. 3B, in process 2, the processor (1044) keeps copying the sequential 20-second recorded videos from first pool of sequential data streams and creates the second pool of sequential data streams till the event completes+predetermined post event recording time. In this example, let's assume the predetermined duration to be, say, 10 seconds. So, the processor (1044) pushes videos from the first pool of sequential data streams till t=94+10=104 seconds.

After that at step 250, the processor (1044) is configured to merge and process the recorded sequential data streams of the event from the second pool to form a single continuous data stream. Continuing the example shown in FIG. 3B, the second pool of sequential data streams would have the following 20 seconds sequential videos copied from first pool of sequential data streams:
21-40 seconds video
41-60 seconds video
61-80 seconds video
81-100 seconds video
101-120 seconds video

So, the processor (1044) at step 250 merges the 5 sequential videos of 20 seconds each into one video. Further, during the processing, it is determined that the required video duration is from Time of Event trigger−Pre Event Time=63-20=43 second to Event Completion time+Post Event Time=94+10=104 seconds. Therefore, during the processing, final video could be trimmed from the 43rd second to the 104th second, thereby capturing the occurrence of the unpredictable event along with predefined pre and post event time. The final video may then be tagged for post analysis. The post analysis may simple mean analysing the happenings of the event or future forecasts, depending upon the event.

In an alternate embodiment, another approach may be followed for steps 240 & 250 without departing from the scope of the present invention. At step 240, once the event is triggered, the whole event is recorded/captured as a single data stream/video using the one or more data capturing devices (102) (without any limitation of duration)+the predetermined post event duration and the processor (1044) stores the same in second pool of sequential data streams. So, second pool only has videos of the event plus the predetermined post event time and the first pool only has videos of pre-event time. Then, at step 250, the processor (1044) merges the videos from both first pool and the second pool and further processes them to generate a single video sequence of the event along with the pre-event time and post-event time. The processing may also include trimming of any overlapping portion in the sequential videos from the first pool and the second pool.

In accordance with an embodiment of the present invention, the present system (100) and method (200) is capable of capturing multiple sequential data streams associated with occurrence of multiple events which are random in terms of occurrence and duration, at the same time and/or at different time intervals during the recording. For example: the system (100) is implemented for capturing lightening, and suddenly interval there are two lightening appearances at different places at the same time or one after another. So, the system (100) easily captures both the events in separate videos with predefined pre and post event time.

The present invention is extremely useful in the field of security and surveillance. In security and Surveillance of an establishment which is to be protected from infiltrators, the present invention may be utilised as a perimeter intrusion sensing system (100). Herein, apart from the one or more data capturing devices (102), the one or more sensing devices (106) may include a number of sensors like Fence Vibration Sensor, Optical Fibre Sensor and 3D sensors to work in tandem or independently to provide an event of an infiltrator detection. Additionally, the system (100) may also include one or more alarms or alerts to the owner and enforcement authorities that are raised upon detection of intrusion. When the infiltration is detected by the system (100), the audio and video of the infiltrator (with pre and post video) is automatically recorded by the system (100). The pre video could be used to analyse where the infiltrator came from before the alarm is triggered and the post video could be used to analyse where the infiltrator intruded after infiltration was successful.

Apart from videos, the audio data streams, voice calls and speeches are sequential data streams for audio. In law enforcement, it might so happen that agencies would want to keep a tap on conversations/chats/speeches when particular flagged words or phrases are used. There could be a speech recognition system which can act as a trigger sensor and whenever particular words or phrases are detected in an audio stream, voice calls, chats or speeches, there will be a requirement to record a pre-event-post audio stream for post analysis and prosecution. The same could be extended to text messaging or chatting over social media or instant messengers, where detection of a few flagged words or phrases might be the trigger to record text conversations with pre-trigger-post text recording for post analysis and prosecution.

Similarly, continuous text data is streamed sequentially from any machine which is a software/hardware machine and one such data stream is data logs. The size of data log output by a machine can be in the volumes of gigabytes and hence post analysis on such large recorded logs is almost impossible. For example, there might be triggers like tyre pressure sensors in a car reporting an anomaly or even some words like “Fault and Error” triggers an anomaly. Once an anomaly is detected, it shall trigger pre-event-post recording of logs for post analysis and fault detection and correction.

Furthermore, there are many radiations that are being received by the earth that the meteorology and astronomy departments continuously capture with sensors. Such radiations are a sequential data stream. Such sequential data streams might need to be captured (in terms of amplitude, frequency and phase) at any astronomical event trigger for post analysis. This algorithm can help capture pre-event-post event radiation data.

In addition to above mentioned applications, the present invention may be implemented in multiple areas for detection of unpredictable events. For example, while scanning the surroundings of an airport, a stray aircraft detection is a completely random event in terms of its occurrence as well as duration of occurrence. In another example may involve capturing the surveillance videos around a house, detection of a burglar is a completely random event in terms of its occurrence as well as duration of occurrence. Yet another examples, may include detection of traffic violations, natural phenomenon such as lightening, thunderstorm, sandstorm etc. For example: A lightening could be detected by a simple camera through luminosity detection in the night sky.

During traffic violations, the video of the recorded event along with pre and post event duration, would help the traffic police professionals to gather proof of exactly where, when and how the traffic rules have been violated. For example: if the present system (100) is deployed (without any monitoring) on a traffic signal or a highway for a day, then at the end of the day, the traffic police professionals would have all the separate video files of all the traffic violations (depending on upon sensors used). Otherwise, in the present available solutions, the footage of all day has to be stored, along with the exact time at which violation took place and then manually/semi-automatically with the help of traffic police professionals, the video is extracted and a fine is generated.

The present invention is capable capturing all such events without any wastage of storage space and minimal processing requirements.

Below are some salient technical features of the present invention (as shown in FIG. 3B):
All three processes, Process 1 (recording data stream & creation of first pool), Process 2 (creation of second pool) and Process 3 (merging and processing) are running independently
Process 1 is continuously recording sequential data streams of predefined duration and is maintaining only the predetermined number of sequential data streams in the first pool at a time (i.e. 3 in the illustrated example).
Process 2 (second pool creation) only kicks off when the event is triggered and makes copies of the data streams recorded in the first pool of sequential data streams. It does not make any change to the first pool.
There can be multiple instances of Process 2 in case overlapping random events are triggered and multiple data streams of the different events would be recorded based on their pre event time, event trigger time, event completion time and post event time
Process 3 kicks off only when the Process 2 is completed at t=event completion time+post event time. Each process 2 has an independent process 3 (merging and processing) and at any instant of time there would be as many Process 3 kicked off as the number of process 2 completed.

The present invention offers a number of advantages. Firstly, it provides a cost-effective and technologically advanced solution to the problems of the prior art. Additionally, the solution provided herein is easy to understand and implement. Then, the present invention provides a solution to overcome the storage problem and also provides recording and capturing of a definite time of pre-event data, event data and a definite time of post event data even for an event which is random in terms of its time of occurrence as well as the duration of its occurrence. Moreover since the capture and recording is only for pre-event data, event data and post event data, post analysis becomes very easy as the user would now only have the relevant capture or recording of the data stream and does not need to search or seek for the desired data.

Further, the proposed method and system only record and store the data stream from the devices or sensors when an event is triggered which is random in terms of its time of occurrence as well as its duration. The proposed technique does not consume a lot of space on the disks and only consumes space for the recording of the predefined pre time, duration of the event as well as predefine post time of data stream. As already highlighted in the background section, that the prior arts consume terabytes of storage space, which the present invention does not require. It requires very less processing and gives very accurate results of random event triggered data stream recording.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip- flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

We claim:

1. A method (200) for capturing an event of random occurrence and undefined length from a stream of continuous input data, the method (200) comprising:
recording (210) sequential data streams using one or more data capturing devices (102) monitoring a space (302), each sequential data stream having a predefined duration;
creating (220) a first pool of sequential data streams in a data repository (108) and storing up to a predefined number of sequential data streams at any time in the first pool;
receiving (230) an event trigger from one or more sensing devices (106), indicative of an occurrence of the event which is random in terms of occurrence and duration;
creating (240) a second pool of recorded sequential data streams in the data repository (108) after receiving the event trigger, by copying sequential data streams from the first pool till a completion of the event plus a predetermined duration post the occurrence of the event; and
merging and processing (250) the data streams of the event from the second pool to form a single continuous data stream, thereby capturing the occurrence of the random event along with predefined pre and post event time.

2. The method (200) as claimed in claim 1, further comprising the steps of capturing multiple sequential data streams associated with occurrence of multiple events which are random in terms of occurrence and duration, at the same time and/or at different time intervals during the recording.

3. The method (200) as claimed in claim 1, wherein the continuous data streams are selected from videos, audio data, point cloud data, text data, data points in 2D/3D, noise generated by machines, radiations from an energy source or a combination thereof.

4. The method (200) as claimed in claim 1, wherein the event to be detected is selected from surveillance and security related events, crowd monitoring-based events such as theft, shoplifting, social distancing violations, criminal activity and traffic violations; and natural phenomenon such as lightening, natural disasters, which are random in terms of duration and occurrence.

5. The method (200) as claimed in claim 1, wherein each sequential data stream in the first pool of sequential data streams has a predefined duration ranging from predetermined number of seconds to hours depending upon the available storage space (302).

6. The method (200) as claimed in claim 1, wherein oldest recorded data stream is automatically deleted from the first pool of sequential data streams when number of sequential data streams stored therein exceed the predetermined number, thereby saving a lot of storage pace.

7. The method (200) as claimed in claim 6, wherein the predetermined number of sequential data streams is selected from 3 to 5, depending upon the available storage space (302) and the predefined length of each sequential data stream.

8. The method (200) as claimed in claim 1, wherein the one or more data capturing devices (102) are selected from visual cameras, audio capturing devices, ultrasonic sensors and 3D sensors such as radars, LiDARs, Laser Detection and Ranging (LaDAR), Light Emitting Diode Detection and Ranging (LeDDAR) mmWave Radar, C or K Band Radar, laser scanners and Time of Flight (ToF) sensors.

9. The method (200) as claimed in claim 1, wherein the one or more sensing devices (106) for detecting the occurrence of an event are selected from cameras, ultrasonic sensors, proximity sensors, tamper detection sensors, Infrared sensors, luminosity sensors, Vibration Sensors, Optical Fibre Sensor, acoustic sensors, sound sensors, automotive sensors, chemical sensors, electric current sensors, electric potential sensors, magnetic sensors, radio sensors, environment sensors, weather sensors, moisture sensors, humidity sensors, Flow & fluid velocity sensors, ionizing radiation sensors, subatomic particles sensors, navigation sensors, position sensors, angle sensors, displacement sensors, distance sensors, acceleration sensors, imaging sensors, photon sensors, pressure sensors, force, density & level sensors, thermal sensors, heat & temperature sensors, 3D sensors and a combination thereof.

10. The method (200) as claimed in claim 1, wherein the event trigger may be received from one or more external computing devices selected from PC, laptop, smartphones and PDA that enable a user to manually trigger the event detection.

11. A system (100) for capturing an event of random occurrence and length from a stream of continuous input data, the system (100) comprising:
one or more data capturing devices (102) disposed in a space (302) to be monitored;
a data repository (108);
one or more sensing devices (106); and
a processing module (104) connected with the one or more data capturing devices (102), the data repository (108) and the one or more sensing devices (106), the processing module (104) comprising:
a memory unit (1042) configured to store machine-readable instructions; and
a processor (1044) operably connected with the memory unit (1042), the processor (1044) obtaining the machine-readable instructions from the memory unit (1042), and being configured by the machine-readable instructions to:
record sequential data streams using one or more data capturing devices (102) monitoring a space (302), each sequential data stream having a predefined duration;
create a first pool of sequential data streams in a data repository (108) and storing up to a predefined number of sequential data streams at any time in the first pool;
receive an event trigger from the one or more sensing devices (106), indicative of an occurrence of the event which is random in terms of occurrence and duration;
create a second pool of recorded sequential data streams in the data repository (108) after receiving the event trigger, by copying sequential data streams from the first pool till a completion of the event plus a predetermined duration post the occurrence of the event; and
merge and process the recorded sequential data streams of the event from the first pool and the second pool to form a single continuous data stream, thereby capturing the occurrence of the unpredictable event along with predefined pre and post event time.

12. The system (100) as claimed in claim 11, wherein the processor (1044) is configured to capture multiple sequential data streams associated with occurrence of multiple events which are random in terms of occurrence and duration, at the same time and/or at different time intervals during the recording.

13. The system (100) as claimed in claim 12, wherein the sequential data streams are selected from videos, audio data, point cloud data, text data, data points in 2D/3D, noise generated by machines, radiations from an energy source or a combination thereof.

14. The system (100) as claimed in claim 11, wherein the event to be detected is selected from surveillance and security related events, crowd monitoring-based events such as theft, shoplifting, social distancing violations, criminal activity and traffic violations; and natural phenomenon such as lightening, natural disasters, which are random in terms of duration and occurrence.

15. The system (100) as claimed in claim 11, wherein each sequential data stream in the first pool of sequential data streams has a predefined duration ranging from predetermined number of seconds to hours depending upon the available storage space (302).

16. The system (100) as claimed in claim 11, wherein the processor (1044) is configured to delete the oldest recorded data stream automatically from the first pool of sequential data streams when number of sequential data streams stored therein exceed the predetermined number, thereby saving a lot of storage pace.

17. The system (100) as claimed in claim 16, wherein the predetermined number of sequential data streams is selected from 3 to 5, depending upon the available storage space (302) and the predefined length of each sequential data stream.

18. The system (100) as claimed in claim 11, wherein the one or more data capturing devices (102) are selected from visual cameras, audio capturing devices, ultrasonic sensors and 3D sensors such as radars, LiDARs, Laser Detection and Ranging (LaDAR), Light Emitting Diode Detection and Ranging (LeDDAR) mmWave Radar, C or K Band Radar, laser scanners and Time of Flight (ToF) sensors.

19. The system (100) as claimed in claim 11, wherein the one or more sensing devices (106) for detecting the occurrence of an event are selected from cameras, ultrasonic sensors, proximity sensors, tamper detection sensors, Infrared sensors, luminosity sensors, Vibration Sensors, Optical Fibre Sensor, acoustic sensors, sound sensors, automotive sensors, chemical sensors, electric current sensors, electric potential sensors, magnetic sensors, radio sensors, environment sensors, weather sensors, moisture sensors, humidity sensors, Flow & fluid velocity sensors, ionizing radiation sensors, subatomic particles sensors, navigation sensors, position sensors, angle sensors, displacement sensors, distance sensors, acceleration sensors, imaging sensors, photon sensors, pressure sensors, force, density & level sensors, thermal sensors, heat & temperature sensors, 3D sensors and a combination thereof.

20. The system (100) as claimed in claim 11, wherein the system (100) further comprises one or more external computing connected with the processor (1044) and the event trigger is received at the processor (1044) from devices selected from PC, laptop, smartphones and PDA that enable a user to manually trigger the event detection.

21. A method for capturing an event of random occurrence and undefined length from a stream of continuous input data, the method (200) comprising:
recording sequential videos using one or more data capturing devices (102) monitoring a space (302), each sequential video having a predefined duration;
creating a first pool of sequential videos in a data repository (108) and storing up to a predefined number of sequential videos at any time in the first pool;
receiving an event trigger from one or more sensing devices (106), indicative of an occurrence of the event which is random in terms of occurrence and duration;
creating a second pool of recorded sequential videos in the data repository (108) after receiving the event trigger, by copying sequential videos from the first pool till a completion of the event plus a predetermined duration post the occurrence of the event; and
merging and processing the sequential videos of the event from the second pool to form a single video sequence, thereby capturing the occurrence of the unpredictable event along with predefined pre and post event time.
